(19) United States
(12) Patent Application Publication
(10) Pub. No.: US 2018/0372406 A1
(43) Pub. Date: Dec. 27, 2018

(54) GRAIN BIN WITH TEMPERATURE AND MOISTURE SENSOR CABLES

(71) Applicant: Ag Growth International Inc., Manitoba (CA)

(72) Inventors: Erron Leafloor, Manitoba (CA); Neil Evenson, Manitoba (CA); Tim Strydhorst, Manitoba (CA); Craig Wallace, Manitoba (CA)

(21) Appl. No.: 16/014,282

(22) Filed: Jun. 21, 2018

Related U.S. Application Data
(60) Provisional application No. 62/523,137, filed on Jun. 21, 2017.

(51) Int. Cl. F26B 9/06; F26B 25/22; G01K 1/02; F26B 21/10; G01K 1/14

(52) U.S. Cl. CPC F26B 9/063; F26B 25/22; G01K 1/024; F26B 2200/06; G01K 1/14; G01K 1/026; F26B 21/10

(57) ABSTRACT

A sensor cable for measuring moisture inside a grain bin includes a moisture sensor connected to a moisture sensor wire and a pair of holes in the sensor cable. The holes are associated with the moisture sensor to enable the moisture sensor to sense moisture via both of the holes. In one implementation, a moisture sensor is connected to a 3-wire interface having separate power and data wires, thereby increasing the read speed. In one implementation, the moisture sensor is encapsulated within a node that is flush with the sensor cable to minimize load on the sensor cable from the surrounding grain.

### TECHNICAL FIELD

The present invention relates generally to grain bins and more specifically to techniques for measuring temperature and moisture of grain being stored inside grain bins.

### BACKGROUND

Grain bins are used to store grain. The moisture and temperature inside the grain bin determine how long the grain can be stored. Moisture and temperature measurements inside the grain bin also enable climate control devices to regulate the temperature and/or moisture content of the grain inside the grain bin. Estimating the moisture content of grain is typically accomplished by measuring the moisture or relative humidity of the air surrounding the grain using one or more moisture sensors.

Temperature and moisture sensor cables are used in the agricultural industry for monitoring grain conditions. These sensor cables are typically suspended from the roof of the grain bin, but other methods of mounting sensors are also possible (e.g. through the sidewall of the bin or suspended (interspersed) in the grain.

Conventional temperature and moisture cables use a 1-wire communication protocol on a 2-wire interface. In this conventional configuration, one wire carries both power and data while the other wire is the ground wire. ModBUS and other serial communication methods have also been employed by some as part of a network of temperature and moisture monitoring devices in a bin.

Improved technologies for measuring moisture inside grain bins are highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

Accordingly, one inventive aspect of the present disclosure is a sensor cable for measuring moisture inside a grain bin. The sensor cable includes a moisture sensor connected to a moisture sensor wire and a pair of holes in the sensor cable, wherein the holes are associated with the moisture sensor to enable the moisture sensor to sense moisture entering the interior of the cable via both of the holes.

Another inventive aspect of the present disclosure is a sensor cable for measuring moisture inside a grain bin, the sensor cable comprising a moisture sensor connected to a moisture sensor wire and a hole in the sensor cable, wherein the hole is associated with the moisture sensor to enable the moisture sensor to sense moisture entering the interior of the cable via the hole, wherein the moisture sensor is disposed within a node that is substantially flush with the sensor cable.

Yet another inventive aspect of the present disclosure is a sensor cable for measuring moisture inside a grain bin, the sensor cable comprising a moisture sensor connected to a 3-wire interface having separate power and data wires and a hole in the sensor cable, wherein the hole is associated with the moisture sensor to enable the moisture sensor to sense moisture entering the interior of the cable via the hole.

These sensor cables may be part of a system having one or more grain bins. In one implementation, a plurality of moisture sensors are disposed along each sensor cable optionally interspersed with temperature sensors. A control device may be disposed on the grain bin to receive moisture signals from the moisture sensors. The control device may be communicatively connected to a wireless transceiver to wirelessly transmit moisture data to a remote computing device.

Other aspects of the invention may become apparent from the description and drawings.

### BRIEF DESCRIPTION OF THE DRAWINGS

Further features and advantages of the present invention will become apparent from the following detailed description, taken in combination with the appended drawings in which:

FIG. 1 is a schematic depiction of a system for storing grain in which sensor cables are suspended inside each of the grain bins to measure temperature and moisture.

FIG. 2 is a schematic view of a control device connected to three sensor cables.

FIG. 3 is a side view of a sensor cable.

FIG. 4 is an isometric view of a lower portion of the sensor cable of FIG. 3.

FIG. 5 is an enlarged view of Detail A of FIG. 3.

FIG. 6 is an enlarged view of Detail B of FIG. 3.

FIG. 7 is a side view of a sensor cable with roof-mounting hardware and floor-mounting hardware.

It will be noted that throughout the appended drawings, like features are identified by like reference numerals.

### DETAILED DESCRIPTION

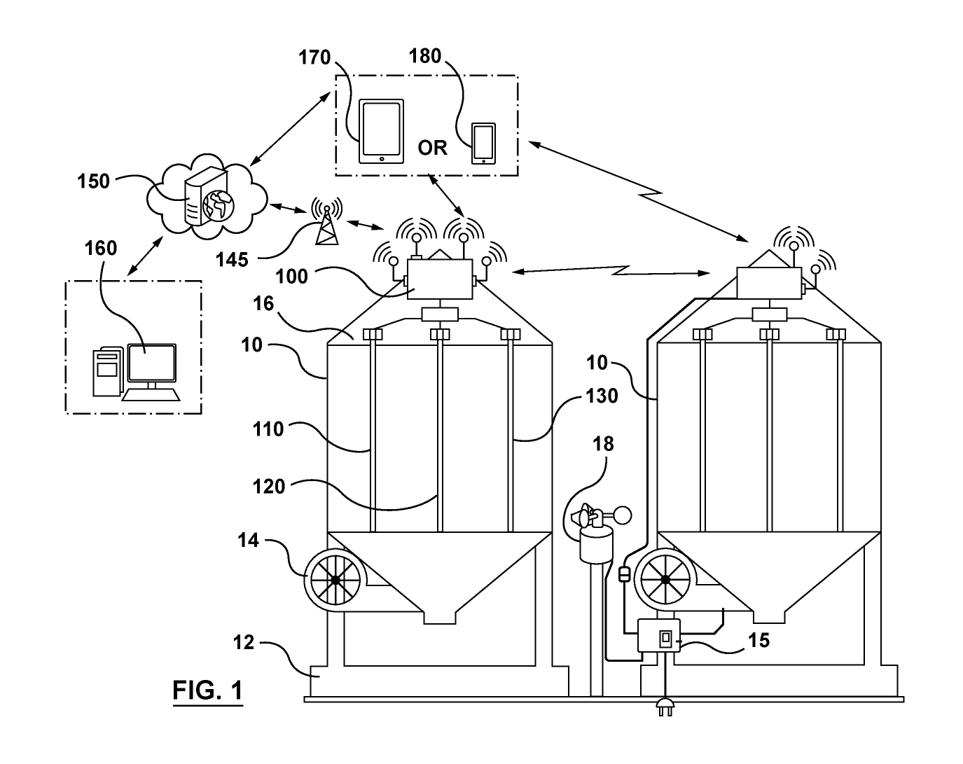

Depicted by way of example in FIG. 1 is a system for storing grain (or other equivalent substances). In the embodiment of FIG. 1, the system has a plurality of grain bins 10 although the system may have only a single grain bin in one embodiment. Although the system is depicted in FIG. 1 having four grain bins 10, it will be appreciated that the number of grain bins may be varied in other embodiments. As depicted by way of example in FIG. 1, each grain bin 10 may have a base 12, an aeration system 14 having a fan, and a roof 16. Optionally, the grain bin(s) may have a mini weather station 18. The mini weather station may be mounted on the bin or may be a standalone unit. In at least one embodiment, the grain bin includes a means of controlling the operation of the fans of the bin's aeration system. The type of grain bin shown in FIG. 1 is also exemplary; other types of grain bins may be used having other sizes, geometries and configurations.

In the system depicted by way of example in FIG. 1, each grain bin 10 includes a control device 100 whose function will be described in greater detail below. In the system of FIG. 1, there are one or more sensor cables for measuring the temperature and moisture inside the grain bins. Each of the sensor cables is connected to the control device 100. In the specific embodiment shown in FIG. 1, there are three sensor cables 110, 120, 130 within each grain bin 10 although the number, length, spacing, and type of sensor cables may be varied in other embodiments. Although the sensor cables are connected to a common control device 100 within each grain bin, it will be appreciated that in other embodiments, there may be more than one control device per grain bin. The control device 100 may be disposed on an upper portion of the grain bin, e.g. on the roof, on an upper wall portion or underneath the roof. The control device is configured for receiving moisture measurement signals and also optionally temperature measurement signals from the moisture sensors and/or temperature sensors. The control device may be disposed elsewhere on the grain bin, and may be responsible for functions in addition to receiving data from temperature and moisture sensors, in other embodiments.

In the embodiment depicted by way of example in FIG. 1, the system also includes a wireless transmitter 140 which may be mounted on each grain bin 10 for wirelessly transmitting moisture and/or temperature data obtained from the sensor cables for the particular grain bin. The wireless transmitter 140 may be, for example, a cellular data transmitter, Wi-Fi transmitter or any other suitable RF transmitter. Data may be transmitted by a wireless gateway, access point, switch or router 145 to a cloud server 150 or directly to a computing device (160, 170, 180). The temperature and moisture data may be received remotely by a remote computing device, e.g. a desktop or laptop computer 160, tablet 170 or smart phone 180 (i.e. a wireless communications device). The remote computing device 160, 170, 180 may include a wireless receiver or wired data receiver connected to a data network, e.g. the Internet, local area network, etc, to receive the data from the control device 100. Instead of the illustrated wireless transmitter 140, the system may have a wireline data transmitter (e.g. modem, router or equivalent) to provide a wireline data connection from the transmitter at the grain bin to the remote computing device. Instead of a wireless (or wireline) transmitter 140, the system may have a data transceiver capable of both transmitting and receiving data. The transceiver is able to receive commands from the remote computing device to request data and/or control the aeration system or other bin-related devices.

As depicted by way of example in FIG. 1, each grain bin 10 has multiple sensor cables 110, 120, 130 suspended from the roof 16 of the grain bin. In one embodiment, each sensor cable 110, 120, 130 includes a hollow (tubular) structural cable having an upper end mounted to the roof 16 of the grain bin 10 such that the structural cable is suspended inside the grain bin. The hollow structural cable has a central (longitudinal) cavity into which the sensor element cable is inserted. This design not only facilitates field repair but also makes manufacturing more efficient.

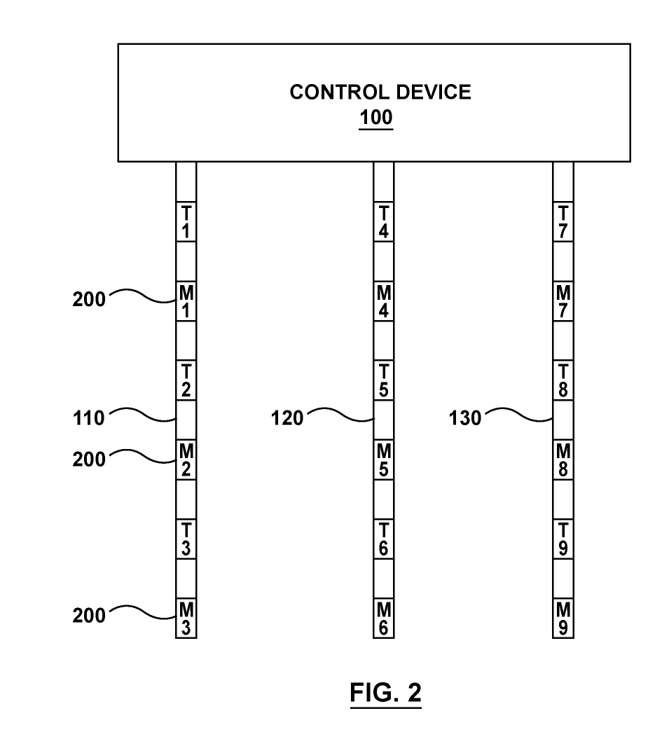

The sensor cables 110, 120, 130 depicted schematically in FIG. 2 are designed to measure both temperature and moisture, i.e. relative humidity (RH), in grain bins. The measurements are performed by sensor cables 110, 120, 130 having a plurality of moisture sensors (M1-M9) denoted also by reference numeral 200 and a plurality of temperature sensors (T1-T9). The sensor cables 110, 120, 130 depicted schematically in FIG. 2 have moisture sensors (M1-M9) and temperature sensors (T1-T9) interspersed equally along the length of each cable. In this specific configuration, the temperature sensors alternate with the moisture sensors. However, in other embodiments, the sensors need not be interspersed nor must the spacing between the sensors be equal. In other embodiments, there may be an unequal number of temperature and moisture sensors. In still other embodiments, the sensor cable may have only moisture sensors 200 (i.e. no temperature sensors on the cable). In yet another embodiment, the sensor cable may have only a single moisture sensor 200 although it will be appreciated that multiple sensors per cable are preferable to provide readings at different depths of grain stored in the grain bin to thereby provide a better overall assessment of the grain condition within the grain bin. In other embodiments, there may be sensors for collecting measurements about other grain conditions such as, for example, detecting the presence of fumigants, grain pressure, CO₂ content and/or airflow.

In one embodiment, a first wire provides a data channel, a second wire provides a power channel and a third wire provides a ground. In this embodiment, the temperature and moisture sensors share the data channel and the power channel.

In another embodiment, the temperature sensors are connected to a temperature sensor wire, i.e. a first wire, while the moisture sensors are connected to a moisture sensor wire, i.e. a second wire distinct from the first wire. In this alternate embodiment, there are separate data channels (on separate wires) but a common power wire and a common ground wire.

The control device 100 is configured to cause the moisture and/or temperature sensors of each sensor cable to initiate the moisture and/or temperature measurements. The control device may initiate measurement automatically (i.e. programmatically) or manually (in response to a user command) or a combination thereof. The control device 100 is also configured to receive and optionally store the measurement signals from the sensors. The control device 100 may be configured to convert the analog measurement signals to digital data using a analog-to-digital converter but, in another embodiment, the analog-to-digital (A/D) conversion occurs on the sensor chip. The control device 100 may store information identifying the location of the sensors spatially within the bin. After the data is collected it may be transmitted wirelessly to the remote computing device and/or to a cloud server as shown in FIG. 1. Data may be transmitted continuously (i.e. in real-time as it is received) or in batches (i.e. delayed after accumulating a predetermined amount of data or after a predetermined period of time has elapsed). Using a grain moisture algorithm, the moisture data (relative humidity data) sensed by the sensor cables is converted into grain moisture values. In the case of a cloud server implementation, a user (or multiple users) can access the data on the cloud server through either a web interface or a mobile application.

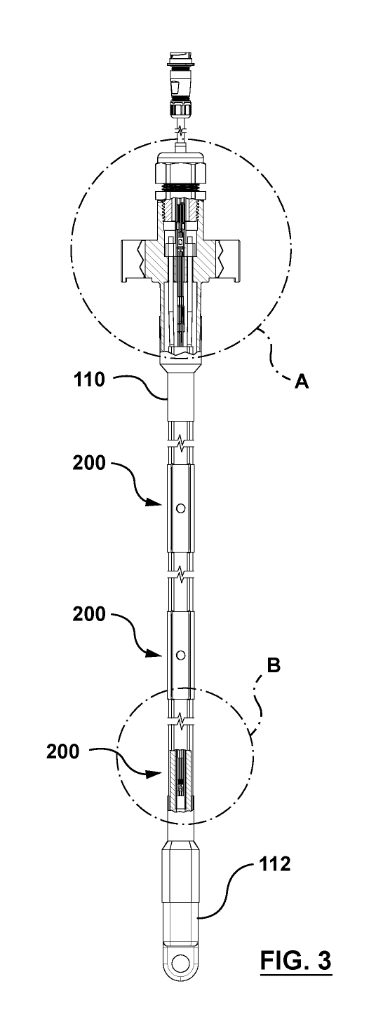

FIG. 3 depicts an embodiment of a sensor cable 110. In this embodiment, each of the moisture sensors 200 along the sensor cable 110 is encapsulated, e.g. encased or enshrouded within a metal enclosure. The sensor cable has a cable end 112.

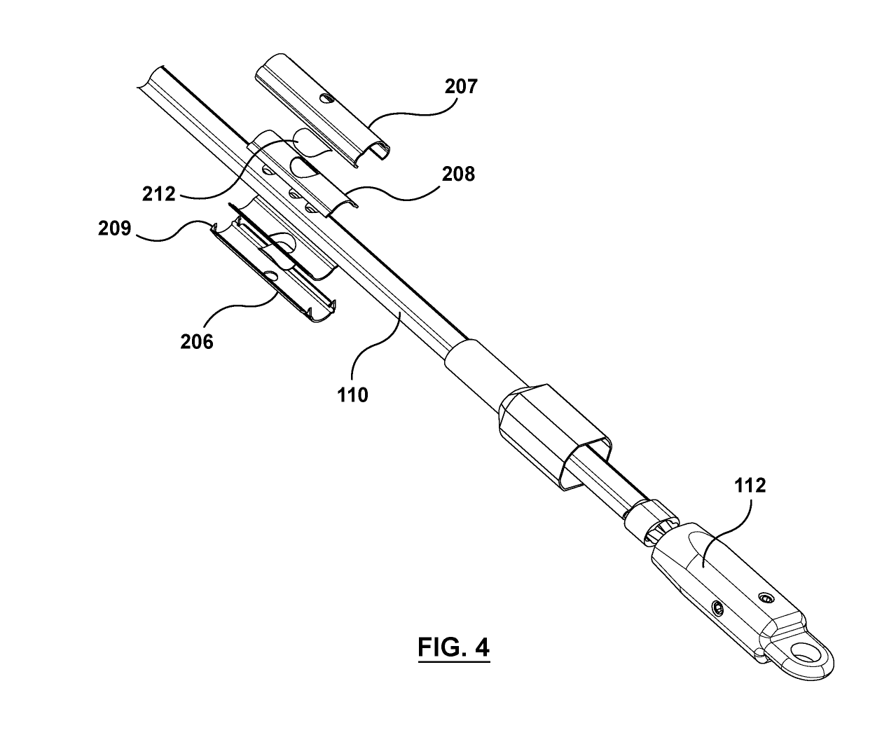

As depicted by way of example in FIG. 4, the enclosure in one particular embodiment is made from two pieces, halves or components of formed metal 206, 207 (i.e. crimping elements) that are crimped together and attached, e.g. glued or sealed with moisture sealing tape 208, to the structural element of the cable. The crimping elements are held in place on the cable through the crimping action onto the cable jacket. In the illustrated embodiment, one or more of the crimping elements 206, 207 has protrusions 209 that mechanically fasten the crimping element to the cable without negatively affecting the structural cable portion of the cable after the crimping elements 206, 207 are mechanically fastened together. In one embodiment a series of teeth or tines at the ends of element 206 embed into the structural cable. In addition to providing a mechanical fastening, this also provides electrical grounding between the sensor node and the cable to dissipate electrostatic charge. The sealing tape 208 is primarily for providing a moisture seal between the crimping element and cable jacket, and is not relied upon for any structural strength.

In the illustrated embodiment, each piece 206, 207 has a hole for moisture to reach the respective moisture sensor. In some embodiments, there is a hole associated with each moisture sensor. In at least one embodiment, the hole is aligned with the moisture sensor although it will be appreciated that the hole need not be exactly aligned for the moisture sensor to be operable. Each moisture sensor 200 is also protected by a filtering membrane (or air filter or moisture filter 212) installed between the enclosure and the moisture sensor 200 and covering the hole in the enclosure. There may be a single hole exposing the moisture sensor or a pair of holes. A pair of holes provides greater measurement accuracy and range. The holes may be circular (round), oval or other shapes. In one embodiment, there may be a different hole shape in the top versus the bottom of the hole (e.g. a rectangular shape on top with a round shape on the bottom). In the case of a pair of holes, the holes may have different shapes, e.g. one round and the other oval.

The combination of the moisture sensor, the enclosure and the filtering membrane is referred to herein as a node. The node, in one embodiment, is substantially flush with the cable. Such a design is an improvement over prior-art cables in which the nodes bulge outwardly relative to the cable, thereby providing surfaces on which the grain may exert an undesirable load on the cable. The undesirable loading of the cable is thus obviated by providing the nodes that are flush with the cable relative to the outer surface of the cable on which the sensor holes are located. Substantially flush in this specification means that the diameter of the node does not exceed the diameter of the cable by more than 25%, preferably no more than 15%, and more preferably no more than 10% and even more preferably no more than 5%.

The enclosure provides both structural protection for the sensor from environmental factors, protection from mechanical damage due to flexure of the cable, and enables fast propagation of temperature and moisture signals towards the sensing element.

In one embodiment, the sensor cable has a communication wire separate from the structural cable. Unlike some prior-art cables in which the sensors are soldered to the cable, the -three wire interface in at least one embodiment is freely suspended inside the central cavity of the structural cable. In this embodiment, the 3-wire interface and its sensors can be pulled up through the cable for maintenance or repair and re-inserted into central passageway of the structural cable.

Each moisture sensor is held, for example, by glue, sealant, or mechanical fastener which also acts as an air transfer barrier between sensors at a regular interval along the cable, e.g. every 4 feet although the interval need not be regular nor does the spacing have to be 4 feet. This sealant creates an internal air cavity around the moisture sensor that is in fluid communication with outside air through the moisture node holes or ports. This sealant also separates the internal air cavity from other sensors along the cable, and from air within the cable cavity between the sensors. In this embodiment, as introduced above, each node is substantially flush with the cable to minimize strain on the cable due to grain loading on the cable. Filter elements prevent dust from clogging the sensors, but allows moisture-containing air to pass through. Metallic crimps (which may be made of stainless steel) are used in this embodiment to hold each sensor in place. The crimped node shortens manufacturing time. In one embodiment, there is a filter (membrane) covering the hole on each side of cable, thereby enabling moisture sensing from two directions.

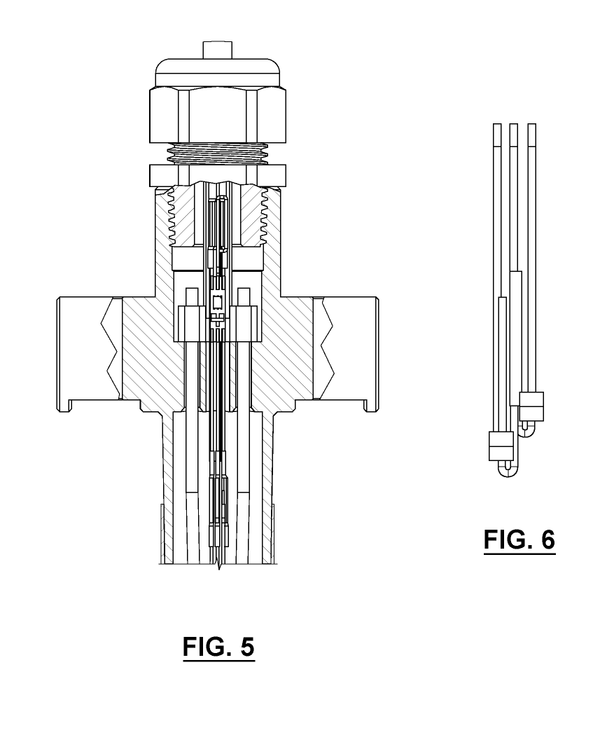

FIG. 5 is an enlarged view of Detail A of FIG. 3. In this embodiment, the sensor cable may have a memory module.

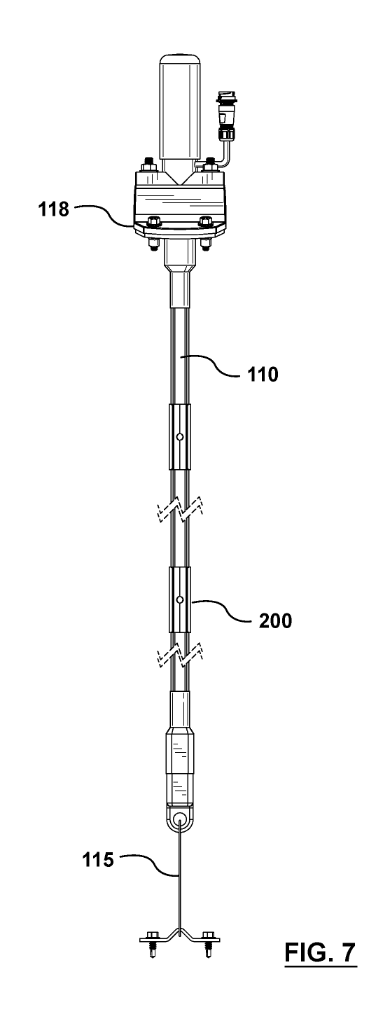

FIG. 6 is an enlarged view of Detail B of FIG. 3. This detailed view shows the three-wire configuration.

Some of the key benefits provided by the embodiments of this invention are as follows:

(1) The sensor in at least one embodiment is a removable/replaceable sensor insert. If one of the sensors is broken the particular sensor insert can be replaced without scrapping the structural element.

(2) The node is substantially flush with the sensor cable in at least one embodiment so that the friction between the cable and the grain is lower than for prior-art cables.

(3) Holes on two sides of the node in at least one embodiment enables sensing of moisture from two sides, thus increasing the accuracy and range of the moisture measurement.

(4) A structural cable profile in at least one embodiment is common between the temperature and moisture cables.

(5) The assembly process for the insert in at least one embodiment is common between the temperature and moisture cables.

(6) A common communication protocol in at least one embodiment can be used between the temperature and moisture cables. In one embodiment, a 3-wire interface with a dedicated data channel improves read speed. In one embodiment, the system uses a 3-wire interface with separate data and power wires. This provides faster read speeds than the prior-art 2-wire interface. The system may implement a 1-wire communication protocol to be compatible with prior-art sensor cables.

In one embodiment, each cable has an electrically erasable programmable read-only memory (EEPROM) chip which enables mapping of the sensor locations along the cable. This shortens the read time for the cable and improves the accuracy of a control device 100 spatially locating the source of measurements from the cable when receiving data from the sensors . In a variant, the EEPROM chip may be replaced with another suitable type of non-volatile memory. In another embodiment, there may be one EEPROM chip for mapping two or more cables.

FIG. 7 is a side view of a sensor cable 110 having moisture sensors 200 and further including roof-mounting hardware 118 and floor-mounting hardware 115. The hardware may include any suitable fastener, connector or mechanism that secures the cable to the floor or roof. In one embodiment, the end of the sensor cable 110 has a breakable connector that is designed as a mechanical fuse. This provides a controlled point of failure on the cable to avoid damaging bin roofs. The roof-mounting hardware may contain a mechanical fuse. The floor-mounting hardware may also contain a mechanical fuse.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed devices and systems might be embodied in other specific forms without departing from the scope of the present disclosure. The present examples are to be considered as illustrative and not restrictive, and the intention is not to be limited to the details given herein. For example, the various devices and systems may be combined or integrated in another system or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A sensor cable for measuring moisture inside a grain bin, the sensor cable comprising:
a moisture sensor connected to a moisture sensor wire; and
a pair of holes in the sensor cable, wherein the holes are associated with the moisture sensor to enable the moisture sensor to sense moisture via both of the holes.

2. The sensor cable of claim 1 further comprising air filters on the holes and crimping elements for attaching the air filters.

3. The sensor cable of claim 2 wherein the crimping elements provide a moisture seal and electrically ground the sensor.

4. The sensor cable of claim 1 comprising a plurality of moisture sensors and a plurality of temperature sensors.

5. A sensor cable for measuring moisture inside a grain bin, the sensor cable comprising:
a moisture sensor connected to a moisture sensor wire; and
a hole in the sensor cable, wherein the hole is associated with the moisture sensor to enable the moisture sensor to sense moisture via the hole;
wherein the moisture sensor is disposed within a node that is substantially flush with the sensor cable.

6. The sensor cable of claim 5 comprising a plurality of moisture sensors and a plurality of temperature sensors.

7. A sensor cable for measuring moisture inside a grain bin, the sensor cable comprising:
a moisture sensor connected to a 3-wire interface having separate power and data wires; and
a hole in the sensor cable, wherein the hole is associated with the moisture sensor to enable the moisture sensor to sense moisture via the hole.

8. The sensor cable of claim 7 comprising a plurality of moisture sensors and a plurality of temperature sensors.

9. A system for measuring moisture, the system comprising:
a grain bin;
a sensor cable disposed inside the grain bin, the sensor cable having:
a moisture sensor connected to a moisture sensor wire; and
a pair of holes in the sensor cable, wherein the holes are associated with the moisture sensor to enable the moisture sensor to sense moisture via both of the holes.

10. The system of claim 9 further comprising a control device disposed on the grain bin for receiving moisture measurement signals from the moisture sensor.

11. The system of claim 10 further comprising a wireless transmitter connected to the control device for transmitting moisture data to a remotely located computing device.

12. The system of claim 11 wherein the sensor cable is suspended from a roof of the grain bin and wherein the sensor cable comprises a plurality of moisture sensors and a plurality of temperature sensors.

13. A system for measuring moisture, the system comprising:
a grain bin;
a sensor cable disposed inside the grain bin, the sensor cable having:
a moisture sensor connected to a moisture sensor wire; and
a hole in the sensor cable, wherein the hole is associated with the moisture sensor to enable the moisture sensor to sense moisture via the hole;
wherein the moisture sensor is disposed within a node that is substantially flush with the sensor cable.

14. The system of claim 13 further comprising a control device disposed on the grain bin for receiving moisture measurement signals from the moisture sensor.

15. The system of claim 14 further comprising a wireless transmitter connected to the control device for transmitting moisture data to a remotely located computing device.

16. The system of claim 15 wherein the sensor cable is suspended from a roof of the grain bin and wherein the sensor cable comprises a plurality of moisture sensors and a plurality of temperature sensors.

17. A system for measuring moisture, the system comprising:
a grain bin;
a sensor cable disposed inside the grain bin, the sensor cable having:
a moisture sensor connected to a 3-wire interface having separate power and data wires; and
a hole in the sensor cable, wherein the hole is associated with the moisture sensor to enable the moisture sensor to sense moisture via the hole.

18. The system of claim 17 further comprising a control device disposed on the grain bin for receiving moisture measurement signals from the moisture sensor.

19. The system of claim 18 further comprising a wireless transmitter connected to the control device for transmitting moisture data to a remotely located computing device.

20. The system of claim 19 wherein the sensor cable is suspended from a roof of the grain bin and wherein the sensor cable comprises a plurality of moisture sensors and a plurality of temperature sensors.
